(19) United States
(12) Patent Application Publication
(10) Pub. No.: US 2025/0217594 A1
(43) Pub. Date: Jul. 3, 2025

(54) METHOD, ELECTRONIC DEVICE AND COMPUTER-READABLE STORAGE MEDIUM FOR EXTRACTING ENTITY RELATIONSHIPS

(71) Applicant: BEIJING BAIDU NETCOM SCIENCE TECHNOLOGY CO., LTD., Beijing (CN)

(72) Inventors: Jingbo ZHOU, Beijing (CN); Shuangli LI, Beijing (CN); Hui XIONG, Beijing (CN)

(73) Assignee: BEIJING BAIDU NETCOM SCIENCE TECHNOLOGY CO., LTD., Beijing (CN)

(21) Appl. No.: 19/080,056

(22) Filed: Mar. 14, 2025

(30) Foreign Application Priority Data
Dec. 3, 2024 (CN) 202411765486.8

(51) Int. Cl. G06F 40/295; G06F 16/3332

(52) U.S. Cl. CPC G06F 40/295; G06F 16/3334

(57) ABSTRACT

A method, electronic device and computer-readable storage medium for extracting entity relationships, which relates to artificial intelligence technologies such as natural language processing, knowledge graphs, deep learning, and large language models. The method for extracting entity relationships includes: inputting a target long text into a target large language model to obtain a target keyword list based on an output result of the target large language model; inputting the target keyword list into multiple target relationship agents respectively to obtain multiple target regular expressions corresponding to different entity relationships based on output results of the multiple target relationship agents; and processing texts in a preset text set using the multiple target regular expressions to obtain entity relationship extraction results.

### CROSS-REFERENCE TO RELATED APPLICATION

The present disclosure claims the priority and benefit of Chinese Patent Application No. 202411765486.8, filed on Dec. 3, 2024, entitled “METHOD, APPARATUS, ELECTRONIC DEVICE AND COMPUTER-READABLE STORAGE MEDIUM FOR EXTRACTING ENTITY RELATIONSHIPS”. The disclosure of the above application is incorporated herein by reference in its entirety.

### TECHNICAL FIELD

The present disclosure relates to the field of computer technology, particularly to artificial intelligence technologies such as natural language processing, knowledge graphs, deep learning, and large language models. A method, electronic device and computer-readable storage medium for extracting entity relationships are provided.

### BACKGROUND

Entity relationship extraction is used to identify and extract relationships among entities from unstructured text and represent the relationships in a structured form, which is a crucial information extraction task. However, traditional natural language processing (NLP) methods face challenges such as insufficient understanding capability and limited reasoning ability when dealing with a long text and complex semantic relationship, resulting in low accuracy and efficiency in relationship extraction.

In recent years, the emergence of large language models (LLM) has brought new opportunities for relationship extraction. However, directly using large language models for relationship extraction faces challenges such as enormous computational resource consumption and high costs, especially in long text scenarios, which greatly increases computational burden and hardware and time costs. Therefore, how to improve the efficiency of entity relationship extraction while maintaining the powerful text understanding capability of large language models has become a pressing technical problem.

### SUMMARY

According to a first aspect of the present disclosure, a method for extracting entity relationships is provided, including: inputting a target long text into a target large language model to obtain a target keyword list based on an output result of the target large language model; inputting the target keyword list into multiple target relationship agents respectively to obtain multiple target regular expressions corresponding to different entity relationships based on output results of the multiple target relationship agents; and processing texts in a preset text set using the multiple target regular expressions to obtain entity relationship extraction results.

According to a second aspect of the present disclosure, an electronic device is provided, including: at least one processor; and a memory communicatively connected to the at least one processor; where the memory stores instructions executable by the at least one processor to cause the at least one processor to perform the aforementioned method.

According to a third aspect of the present disclosure, a non-transitory computer-readable storage medium storing computer instructions is provided, where the computer instructions are used to cause the computer to perform the aforementioned method.

It should be understood that the content described in this section is not intended to identify key or essential features of the embodiments of the present disclosure, nor is it intended to limit the scope of the present disclosure. Other features of the present disclosure will become readily apparent through the following description.

### BRIEF DESCRIPTION OF THE DRAWINGS

The drawings are used for better understanding the present solution and do not constitute a limitation of the present disclosure. In the drawings,

FIG. 1 is a schematic diagram according to a first embodiment of the present disclosure;

FIG. 2 is a schematic diagram according to a second embodiment of the present disclosure;

FIG. 3 is a schematic diagram according to a third embodiment of the present disclosure;

FIG. 4 is a schematic diagram according to a fourth embodiment of the present disclosure;

FIG. 5 is a schematic diagram according to a fifth embodiment of the present disclosure;

FIG. 6 is a schematic diagram according to a sixth embodiment of the present disclosure; and

FIG. 7 is a block diagram of an electronic device for implementing the method for extracting entity relationship according to embodiments of the present disclosure.

### DETAILED DESCRIPTION OF EMBODIMENTS

The following part will illustrate exemplary embodiments of the present disclosure with reference to the drawings, including various details of the embodiments of the present disclosure for a better understanding. The embodiments should be regarded only as exemplary ones. Therefore, those skilled in the art should appreciate that various changes or modifications may be made with respect to the embodiments described herein without departing from the scope and spirit of the present disclosure. Similarly, for clarity and conciseness, the descriptions of the known functions and structures are omitted in the descriptions below.

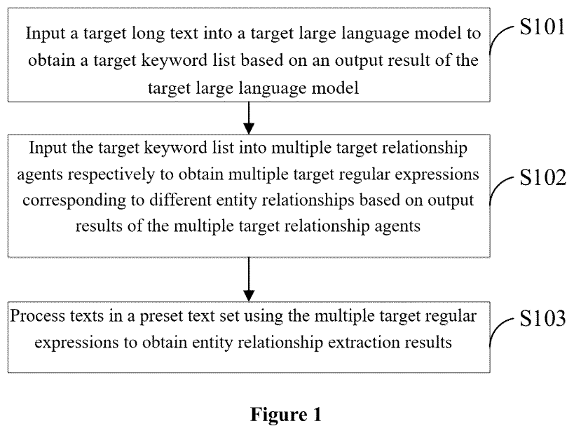

FIG. 1 is a schematic diagram according to a first embodiment of the present disclosure. As shown in FIG. 1, the method for extracting entity relationships in this embodiment specifically includes the following steps:

S101: Input a target long text into a target large language model to obtain a target keyword list based on an output result of the target large language model;

S102: Input the target keyword list into multiple target relationship agents respectively to obtain multiple target regular expressions corresponding to different entity relationships based on output results of the multiple target relationship agents; and

S103: Process texts in a preset text set using the multiple target regular expressions to obtain entity relationship extraction results.

The method for extracting entity relationships in this embodiment, on one hand, leverages the text understanding capability of the large language model to obtain a target keyword list based on the target long text, which can improve the accuracy of the obtained keyword list. On the other hand, the target relationship agents obtain target regular expressions corresponding to respective entity relationships based on the target keyword list, which can simplify the steps of obtaining target regular expressions and reduce the difficulty of obtaining target regular expressions, thereby improving the efficiency and accuracy of entity relationship extraction from the preset text set based on the obtained target regular expressions.

When executing S101, this embodiment may directly obtain a preset long text as the target long text; or obtain a long text corresponding to task information related to entity relationship extraction as the target long text. For example, if the task information is to construct a knowledge graph in the financial domain, this embodiment obtains a long text in the financial domain as the target long text.

In this embodiment, a long text refers to a text with a number of characters greater than a preset threshold, and the target long text and the texts in the preset text set correspond to the same target domain. For example, if the target long text corresponds to the financial domain, then the texts in the preset text set also corresponds to the financial domain; if the target long text corresponds to the legal domain, then the texts in the preset text set also corresponds to the legal domain.

For example, if the target long text corresponds to the financial domain, it may be company financial reports, market analysis reports, etc. If the target long text corresponds to the legal domain, it may be judgment documents, contracts, etc.

It is to be understood that the number of target long texts obtained in S101 of this embodiment may be one or multiple; that is, the target large language model in this embodiment may obtain a keyword list based on a single target long text or multiple target long texts.

Specifically, when executing S101 to input the target long text into the target large language model to obtain the target keyword list based on the output result of the target large language model, the implementation method may be: obtaining a first prompt text (prompt), which is a prompt text corresponding to “keyword extraction task”; inputting the target long text and the first prompt text into the target large language model to obtain the target keyword list based on the output result of the target large language model.

The first prompt text obtained in S101 of this embodiment may be “Extract keywords for entity relationship extraction from the input text.”

To further improve the accuracy of keyword extraction by the target large language model and ensure the extracted keywords meet the requirements of different domains, domain information may also be included in the first prompt text. For example, when the target long text corresponds to the financial domain, the first prompt text may be “Extract keywords for entity relationship extraction in the financial domain from the input text.”

In other words, this embodiment uses the target large language model to extract a target keyword list (corresponding to specific tasks or specific domains) from the input target long text for entity relationship extraction, ensuring that the target keyword list contains sufficient information (i.e., multiple keywords) while reducing noise interference, thereby improving the efficiency of subsequent relationship agents in generating target regular expressions based on the target keyword list.

For example, if the target long text is a financial report in the financial domain, the target keyword list obtained by the target large language model in S101 of this embodiment may include keywords such as “sign”, “guarantee”, “agreement”, etc.

In this embodiment, the target large language model may be open-source large language models such as LLama3, QWen2, GLM4, etc.

After obtaining the target keyword list in S101, this embodiment executes S102 to input the target keyword list into multiple target relationship agents respectively to obtain multiple target regular expressions corresponding to different entity relationships based on the output results of the multiple target relationship agents.

In this embodiment, the relationship agents are the core part of entity relationship extraction, with the main objective of utilizing the target keyword list output by the target large language model to generate rules for entity relationship extraction, i.e., regular expressions corresponding to different entity relationships.

In this embodiment, one relationship agent is responsible for one type of entity relationship, meaning different relationship agents focus only on generating regular expressions for one type of entity relationship. This embodiment can call different relationship agents by calling APIs (Application Programming Interfaces).

It is to be understood that when executing S102, this embodiment may also select multiple target relationship agents from multiple candidate relationship agents based on the domain of the target long text or the task information corresponding to entity relationship extraction, thereby ensuring that the selected target relationship agents correspond to a specific domain or a specific task.

For example, if the domain of the target long text is the financial domain, the target relationship agents in this embodiment may include an agent for “guarantee” relationship, an agent for “signing” relationship, an agent for “agreement” relationship, etc.

Specifically, when executing S102 to input the target keyword list into the multiple target relationship agents respectively to obtain the multiple target regular expressions corresponding to different entity relationships based on the output results of the multiple target relationship agents, the implementation method may be: obtaining a second prompt text, which is a prompt text corresponding to “regular expression generation task”; inputting the target keyword list and the second prompt text into multiple relationship agents respectively; obtaining multiple candidate regular expressions corresponding to different entity relationships based on the output results of the multiple target relationship agents; obtaining multiple target regular expressions corresponding to different entity relationships based on the multiple candidate regular expressions corresponding to different entity relationships.

The second prompt text obtained in S102 of this embodiment may be “Generate regular expressions for extracting entity relationships corresponding to oneself based on the input target keyword list.”

In other words, this embodiment uses target relationship agents, combined with the second prompt text and the target keyword list, to obtain target regular expressions corresponding to specific entity relationships, which can simplify the steps of obtaining the target regular expressions and improve the efficiency of obtaining target regular expressions.

For example, for the “guarantee” relationship agent, based on keywords such as “guarantee”, “sign”, “agreement” in the target keyword list, the generated regular expression corresponding to the “guarantee” relationship may be “{{A}} and {{B}} {0,10} sign {0,10} guarantee agreement”; where {A} and {B} represent different entities, and {0,10} represents 0-10 characters.

In executing S102 to obtain the multiple target regular expressions corresponding to different entity relationships based on the multiple candidate regular expressions corresponding to different entity relationships, this embodiment may directly use the candidate regular expressions corresponding to specific entity relationships as the target regular expressions corresponding to those specific entity relationships.

When executing S102, this embodiment may also combine agent cross-reflection methods, rule filtering, and rule simplification methods to process the candidate regular expressions, and then obtain target regular expressions based on the processing results, thereby further improving the accuracy of the obtained target regular expressions.

After obtaining multiple target regular expressions corresponding to different entity relationships in S102, this embodiment executes S103 to process the text in the preset text set using the multiple target regular expressions to obtain the entity relationship extraction result.

When executing S103 to process the texts in the preset text set using the multiple target regular expressions to obtain the entity relationship extraction results, this embodiment may first match the multiple target regular expressions with the texts in the preset text set to obtain matching texts corresponding to the multiple target regular expressions respectively, then extract entities from the obtained matching texts, and finally form triples each based on the extracted entities and the entity relationships corresponding to a matching text (i.e., the entity relationships corresponding to the target regular expression that match the text), thereby obtaining entity relationship extraction results based on the obtained multiple triples.

Additionally, when executing S103 to process the texts in the preset text set using the multiple target regular expressions to obtain the entity relationship extraction results, this embodiment may also adopt the following approach: match the multiple target regular expressions with the texts in the preset text set to obtain multiple matching texts; construct a training dataset based on the obtained multiple matching texts, entities in each matching text, and entity relationships among the entities; train an initial entity relationship extraction model using the constructed training dataset to obtain a target entity relationship extraction model; and input each text in the preset text set into the target entity relationship extraction model to obtain the entity relationship extraction results based on the output results of the target entity relationship extraction model.

In other words, this embodiment may also construct a training dataset for weak supervision learning based on the matching texts in the preset text set corresponding to target regular expressions, and then use the constructed training dataset to perform weak supervision training on the initial entity relationship extraction model, thereby using the trained target entity relationship extraction model to extract entity relationships from all texts in the preset text set, improving the accuracy and comprehensiveness of the obtained entity relationship extraction results.

It is to be understood that when executing S103 to train the initial entity relationship extraction model using the constructed training dataset, this embodiment may first take a matching text as an input of the initial entity relationship extraction model to obtain a prediction result output by the initial entity relationship extraction model, then calculate a loss function value based on the obtained prediction result and the entities and relationships among entities corresponding to the matching text, and finally adjust the initial entity relationship extraction model using the calculated loss function value to obtain the target entity relationship extraction model, which can output entities and relationships among entities in the text based on the input text.

After obtaining the entity relationship extraction results in S103, this embodiment may complete corresponding tasks based on the obtained entity relationship extraction results, such as constructing knowledge graphs in a specific domain.

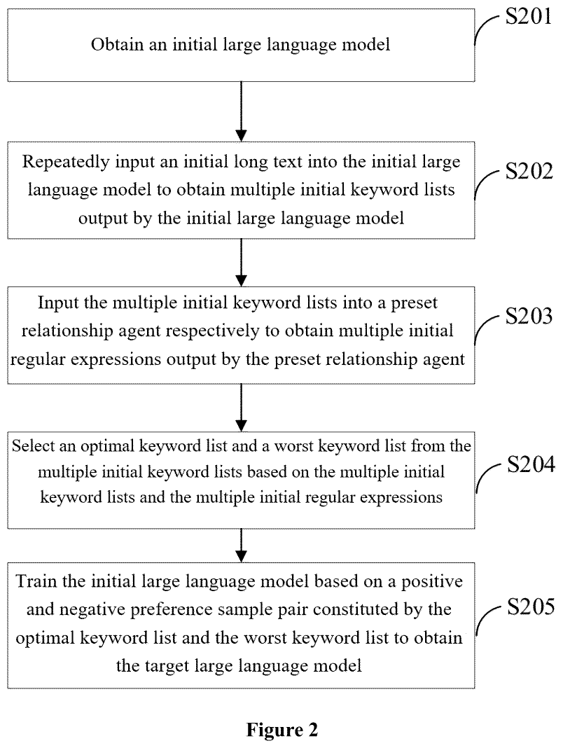

FIG. 2 is a schematic diagram according to a second embodiment of the present disclosure. As shown in FIG. 2, this embodiment may further include the following:

S201: Obtain an initial large language model;

S202: Repeatedly input an initial long text into the initial large language model to obtain multiple initial keyword lists output by the initial large language model;

S203: Input the multiple initial keyword lists into a preset relationship agent respectively to obtain multiple initial regular expressions output by the preset relationship agent;

S204: Select an optimal keyword list and a worst keyword list from the multiple initial keyword lists based on the multiple initial keyword lists and the multiple initial regular expressions; and

S205: Train the initial large language model based on a positive and negative preference sample pair constituted by the optimal keyword list and the worst keyword list to obtain the target large language model.

In other words, this embodiment trains the initial large language model using the Direct Preference Optimization (DPO) method, enabling the initial large language model to perform contrastive learning through obtained positive and negative preference sample pairs. This can improve the accuracy of target keyword lists extracted from long texts by the resulting target large language model, thereby enhancing the accuracy of regular expressions generated by target relationship agents based on the target keyword lists.

When executing S201, this embodiment may directly obtain a preset type of large language model as the initial large language model.

To further improve the accuracy of keyword list extraction by the target large language model, when executing S201, this embodiment may first obtain synthetic data (containing text and corresponding keyword lists) generated by a teacher large language model, then finetune the initial large language model using the obtained synthetic data, enabling the initial large language model to output keyword lists corresponding to input texts based on the input texts.

When executing S202, this embodiment may obtain either a preset long text as the initial long text or a long text corresponding to the target domain as the initial long text, where the target domain may be the domain corresponding to task information.

When executing S203, this embodiment may randomly select one from multiple initial relationship agents corresponding to the target domain as the preset relationship agent, or obtain a pre-configured relationship agent as the preset relationship agent.

When executing S204 to select the optimal keyword list and the worst keyword list from the multiple initial keyword lists based on the multiple initial keyword lists and initial regular expressions, the implementation method may be: using a keyword ranking agent to rank the multiple initial keyword lists to obtain a first ranking result of the multiple initial keyword lists; using a regular expression ranking agent to rank the multiple initial regular expressions to obtain a second ranking result of the multiple initial keyword lists based on the ranking results of the multiple initial regular expressions; and selecting the optimal keyword list and the worst keyword list from the multiple initial keyword lists based on the first ranking result and the second ranking result of the initial keyword lists.

In this embodiment, the keyword ranking agent and regular expression ranking agent respectively act as a keyword ranking expert and a regular expression ranking expert for ranking the initial keyword lists and the initial regular expressions.

When executing S204, this embodiment may first preset scores corresponding to different rankings, e.g., 10 points for first place, 9 points for second place, etc., then obtain final scores for different initial keyword lists based on these preset scores, and finally determine the optimal keyword list (highest score) and worst keyword list (lowest score) from the multiple initial keyword lists based on the final scores.

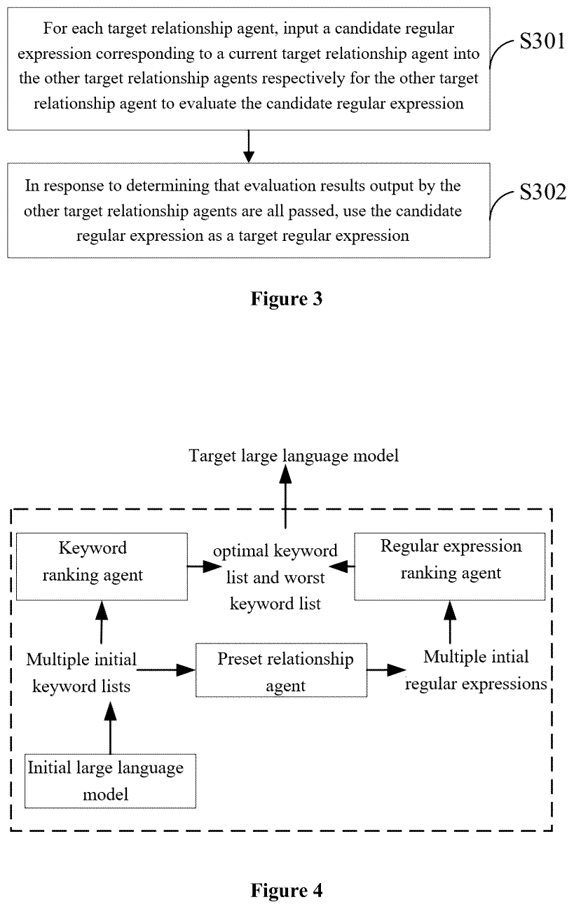

FIG. 3 is a schematic diagram according to a third embodiment of the present disclosure. As shown in FIG. 3, when executing “obtaining multiple target regular expressions corresponding to different entity relationships based on multiple candidate regular expressions corresponding to different entity relationships” in S102, the implementation method may be:

S301: For each target relationship agent, input a candidate regular expression corresponding to a current target relationship agent into the other target relationship agents respectively for the other target relationship agent to evaluate the candidate regular expression; and

S302: In response to determining that evaluation results output by the other target relationship agents are all passed, use the candidate regular expression as a target regular expression.

In other words, this embodiment introduces an agent cross-reflection mechanism, enabling relationship agents to act as judges for each other through information transmission among them, thereby addressing potential errors or hallucinations (i.e., unreasonable regular expressions) that may occur when generating regular expressions. This ensures that relationship agents remain independent while improving the accuracy and effectiveness of generated regular expressions through collaboration, avoiding potential biases from single relationship agents.

When executing S301, this embodiment may also obtain a third prompt text and input the obtained third prompt text along with the candidate regular expression into other target relationship agents respectively.

In this embodiment, the third prompt text corresponds to the “regular expression evaluation task”, for example, “Please evaluate the input regular expression and determine whether it is reasonable.”

To further improve the quality of obtained target regular expressions, after completing cross-reflection among agents, this embodiment may also perform further filtering and simplification of target regular expressions.

When filtering target regular expressions, this embodiment may first match the target regular expressions with the preset text set to obtain matching texts, then calculate the coverage rate of the target regular expression based on the amount of matching texts and the amount of the total texts in the preset text set. If the coverage rate is greater than or equal to a preset coverage threshold, the target regular expression is retained; otherwise, it is filtered out.

When simplifying target regular expressions, this embodiment may determine parent-child relationships between matching texts corresponding to each target regular expression, and only retain target regular expressions corresponding to matching texts with parent relationships.

For example, if target regular expression 1 corresponds to matching texts including text 1, text 2, and text 3, and target regular expression 2 corresponds to matching texts including text 1 and text 2, this embodiment only retains target regular expression 1 to ensure conciseness.

FIG. 4 is a schematic diagram of the fourth embodiment of the present disclosure. FIG. 4 shows the flowchart of obtaining the target large language model: combining a preset relationship agent, a keyword ranking agent, and a regular expression ranking agent to obtain an optimal keyword list and a worst keyword list, then using the optimal keyword list and the worst keyword list to perform Direct Preference Optimization on the initial large language model to obtain the target large language model.

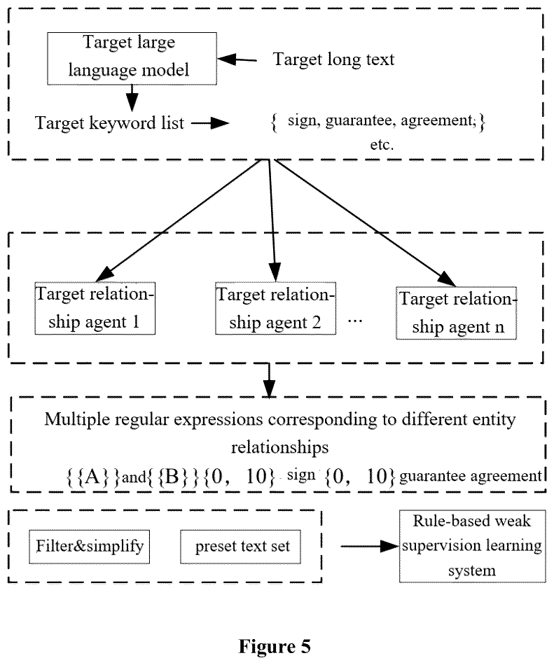

FIG. 5 is a schematic diagram of the fifth embodiment of the present disclosure. FIG. 5 shows the flowchart of entity relationship extraction based on a target large language model and multiple relationship agents: Given a knowledge graph construction task in the financial domain, the target large language model first generates a target keyword list based on the target long text, then inputs this target keyword list into different target relationship agents to obtain target regular expressions output by multiple target relationship agents. After filtering and simplifying the obtained target regular expressions, the processed target regular expressions are integrated as expert rules into a rule-based weak supervision learning system for large-scale text data entity relationship extraction.

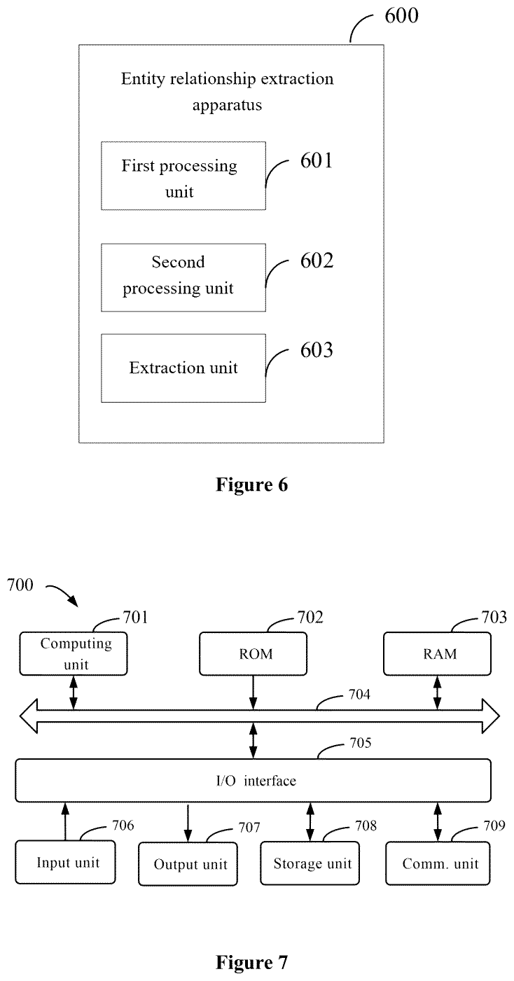

FIG. 6 is a schematic diagram of the sixth embodiment of the present disclosure. As shown in FIG. 6, the entity relationship extraction apparatus 600 includes:

A first processing unit 601 configured to input a target long text into a target large language model to obtain a target keyword list based on an output result of the target large language model;

A second processing unit 602 configured to input the target keyword list into multiple target relationship agents respectively to obtain multiple target regular expressions corresponding to different entity relationships based on output results of the multiple target relationship agents; and

An extraction unit 603 configured to process texts in a preset text set using the multiple target regular expressions to obtain entity relationship extraction results.

The first processing unit 601 may directly obtain the preset long text as the target long text or obtain, according to task information corresponding an entity relationship extraction, a long text corresponding to the task information. For example, if the task is to construct a knowledge graph in a financial domain, this embodiment obtains a long text in financial domain as the target long text.

In this embodiment, a long text refers to a text with a number of characters greater than a preset threshold, and the target long text and the texts in the preset text set correspond to the same target domain.

It is to be understood that the first processing unit 601 may obtain one or multiple target long texts; that is, the target large language model in this embodiment may obtain a keyword list based on a single target long text or multiple target long texts.

Specifically, when the first processing unit 601 inputs the target long text into the target large language model to obtain the target keyword list based on the output result of the target large language model, the implementation method may be: obtaining a first prompt text (i.e., prompt), which is a prompt text corresponding to “keyword extraction task”; inputting the target long text and the first prompt text into the target large language model to obtain target keyword list based on output result of the target large language model.

In other words, the first processing unit 601 uses the target large language model to extract the target keyword list from the input target long text for entity relationship extraction (corresponding to a specific task or domain), ensuring the target keyword list contains sufficient information (i.e., multiple keywords) while reducing noise interference, thereby improving the efficiency of subsequent relationship agents in generating target regular expressions based on the target keyword list.

After the first processing unit 601 obtains the target keyword list, the second processing unit 602 inputs the target keyword list into the multiple target relationship agents respectively to obtain multiple target regular expressions corresponding to different entity relationships based on output results of the multiple target relationship agents.

In this embodiment, the relationship agents are the core part of entity relationship extraction, with the main objective of utilizing target keyword lists output by target large language model to generate rules for entity relationship extraction, i.e., regular expressions corresponding to different entity relationships.

In this embodiment, one relationship agent is responsible for one type of entity relationship, meaning different relationship agents focus only on generating regular expressions for one type of entity relationship. This embodiment can call different relationship agents by calling APIs (Application Programming Interfaces).

It is to be understood that second processing unit 602 may also select multiple target relationship agents from multiple candidate relationship agents based on the domain of target long text or task information corresponding to entity relationship extraction, ensuring that the selected target relationship agents correspond to a specific domain or task.

Specifically, when the second processing unit 602 inputs the target keyword list into the multiple target relationship agents respectively to obtain the multiple target regular expressions corresponding to different entity relationships based on the output results of the multiple target relationship agents, the implementation method may be: obtaining a second prompt text, which is a prompt text corresponding to “regular expression generation task”; inputting the target keyword list and the second prompt text into the multiple relationship agents respectively; obtaining multiple candidate regular expressions corresponding to different entity relationships based on the output results of the multiple target relationship agents; obtaining the multiple target regular expressions corresponding to different entity relationships based on the multiple candidate regular expressions corresponding to different entity relationships.

In other words, the second processing unit 602 uses target relationship agents, combined with the second prompt text and the target keyword list, to obtain target regular expressions corresponding to specific entity relationships, simplifying the steps of obtaining the target regular expressions and improving efficiency of obtaining the target regular expressions.

When obtaining the multiple target regular expressions corresponding to different entity relationships based on the multiple candidate regular expressions corresponding to the different entity relationships, the second processing unit 602 may directly use the candidate regular expressions corresponding to specific entity relationships as the target regular expressions corresponding to the specific entity relationships.

When obtaining the multiple target regular expressions corresponding to different entity relationships based on the multiple candidate regular expressions corresponding to the different entity relationships, the second processing unit 602 may also adopt the following implementation: for each target relationship agent, inputting a candidate regular expression corresponding to a current target relationship agent into the other target relationship agents for the other target relationship agent to evaluate the candidate regular expression; and in response to determining that evaluation results output by the other target relationship agents are all passed, using the candidate regular expressions as the target regular expression.

In other words, the second processing unit 602 introduces an agent cross-reflection mechanism, enabling relationship agents to act as judges for each other through information transmission among them, thereby addressing potential errors or hallucinations (i.e., unreasonable regular expressions) that may occur during regular expression generation. This ensures relationship agents remain independent while improving accuracy and effectiveness through collaboration, avoiding potential biases from single relationship agents.

The second processing unit 602 may also obtain a third prompt text and input the third prompt text and the candidate regular expressions corresponding to the current target relationship agent into the other target relationship agents respectively.

To further improve the quality of obtained target regular expressions, the second processing unit 602 may perform additional filtering and simplification of the target regular expression after completing cross-reflection among agents.

After the second processing unit 602 obtains multiple target regular expressions corresponding to different entity relationships, the extraction unit 603 processes text in the preset text set using these regular expressions to obtain entity relationship extraction results.

When processing the text in the preset text set using the multiple target regular expressions to obtain the entity relationship extraction results, the extraction unit 603 may first match multiple target regular expressions with texts in the preset text set to obtain matching texts corresponding to the multiple target regular expressions respectively, then extract entities from the obtained matching texts, and finally form triples each based on the extracted entities and the entity relationships corresponding to a matching text (i.e., the entity relationships corresponding to the target regular expression that match the text), thereby obtaining entity relationship extraction results based on multiple triples.

Additionally, when processing the texts in the preset text set using the multiple target regular expressions to obtain the entity relationship extraction results, the extraction unit 603 may also adopt another approach: matching the multiple target regular expressions with the texts in the preset text set to obtain multiple matching texts; constructing a training dataset based on the obtained multiple matching texts, entities in each matching text, and entity relationships among the entities; training an initial entity relationship extraction model using the constructed training dataset to obtain a target entity relationship extraction model; and inputting each text in the preset text set into the target entity relationship extraction model to obtain the entity relationship extraction results based on output results of the target entity relationship extraction model.

In other words, the extraction unit 603 may construct a training dataset for weak supervision learning based on matching texts in the preset text set corresponding to the target regular expressions, then use the constructed training dataset to perform weak supervision training on the initial entity relationship extraction model, so as to use the trained target relationship extraction model to extract the entity relationship from all texts in the preset text set, improving accuracy and comprehensiveness of results of the obtained entity relationship extraction results.

It is to be understood that when training the initial entity relationship extraction model using the constructed training dataset, the extraction unit 603 may first take a matching text as an input of the initial entity relationship extraction model to obtain a prediction result output by the initial entity relationship extraction model, then calculate a loss function value based on the obtained prediction result and the entities and relationships among entities corresponding to the matching text, and finally adjust the initial entity relationship extraction model using the calculated loss function values to obtain the target entity relationship extraction model, which can output entities and relationships among entities in the text based on the input text.

After obtaining the entity relationship extraction results, the extraction unit 603 may complete corresponding tasks based on the obtained entity relationship extraction results, such as constructing knowledge graphs in a specific domain.

Additionally, the first processing unit 601 may obtain the target language model through another approach: obtaining an initial large language model; repeatedly inputting an initial long text into the initial large language model to obtain multiple initial keyword lists output by the initial large language model; inputting the multiple initial keyword lists into a preset relationship agent respectively to obtain multiple initial regular expressions output by the preset relationship agent; selecting an optimal keyword list and a worst keyword list from the multiple initial keyword lists based on the multiple initial keyword lists and the multiple initial regular expressions; training the initial large language model based on a positive and negative preference sample pair constituted by the optimal keyword list and the worst keyword list to obtain the target large language model.

When the first processing unit 601 selects the optimal keyword list and the worst keyword list from multiple initial keyword lists based on initial keyword lists and initial regular expressions, the implementation method can be: using a keyword ranking agent to rank the multiple initial keyword lists to obtain a first ranking result of the multiple initial keyword lists; using a regular expression ranking agent to rank the multiple initial regular expressions to obtain a second ranking result of the multiple initial keyword lists based on the ranking results of the initial regular expressions; selecting the optimal keyword list and worst keyword list from the multiple initial keyword lists based on the first and second ranking results of the initial keyword lists.

The first processing unit 601 may first preset scores corresponding to different rankings, e.g., 10 points for first place, 9 points for second place, etc., then obtain final scores for different initial keyword lists based on these preset scores, and finally determine the optimal keyword list (highest score) and worst keyword list (lowest score) from the multiple initial keyword lists based on the final scores.

According to embodiments of the present disclosure, an agent system is also provided which includes: an input module configured to receive an input target long text and a preset text set; a processing module configured to determine an entity relationship extraction task based on the target long text and the preset text set received by the input module, determine a target large language model and multiple target relationship agents based on the entity relationship extraction task, obtain an entity relationship extraction result by calling the target large language model and the multiple target relationship agents to execute the method according to the above embodiments; and an output module configured to output the entity relationship extraction results obtained by the processing module.

Specifically, when obtaining the entity relationship extraction result by calling the target large language model and the multiple target relationship agents, the processing module first inputs a target long text into a target large language model to obtain a target keyword list based on an output result of the target large language model, then inputs the target keyword list into multiple target relationship agents respectively to obtain multiple target regular expressions corresponding to different entity relationships based on output result of the multiple target relationship agents, and finally processes text in a preset text set using the multiple target regular expressions to obtain an entity relationship extraction result.

The technical solution of this disclosure complies with relevant laws and regulations regarding the acquisition, storage, and application of personal information, and does not violate public order and good morals.

According to embodiments of the present disclosure, an electronic device, a computer-readable storage medium, and a computer program product are also provided.

FIG. 7 shows a schematic block diagram of the electronic device for implementing the entity relationship extraction method according to an embodiment of the present disclosure. The electronic device is intended to represent various forms of digital computers, such as laptops, desktop computers, workstations, servers, blade servers, mainframes, and other suitable computers. The electronic device may also represent various forms of mobile devices, such as personal digital assistants, cellular phones, smartphones, wearable devices, and other similar computing devices. The components shown in this article, their connections and relationships, and their functions are merely examples and are not intended to limit the implementation of the present disclosure as described and/or claimed in this article.

As shown in FIG. 7, the device 700 includes a computing unit 701, which may perform various appropriate actions and processes according to a computer program stored in a read-only memory (ROM) 702 or a computer program loaded from a storage unit 708 into a random access memory (RAM) 703. Various programs and data required for the operation of the device 700 may also be stored in the RAM 703. The computing unit 701, ROM 702, and RAM 703 are connected to each other via a bus 704. An input/output (I/O) interface 705 is also connected to the bus 704.

Multiple components of the device 700 are connected to the I/O interface 705, including: an input unit 706, such as a keyboard, mouse, etc.; an output unit 707, such as various types of displays, speakers, etc.; a storage unit 708, such as disks, optical disks, etc.; and a communication unit 709, such as a network card, modem, wireless communication transceiver, etc. The communication unit 709 allows the device 700 to exchange information/data with other devices over computer networks such as the Internet and/or various telecommunications networks.

The computing unit 701 may be various general-purpose and/or special-purpose processing components with processing and computing capabilities. Some examples of the computing unit 701 include but are not limited to central processing units (CPUs), graphics processing units (GPUs), various dedicated artificial intelligence (AI) computing chips, various computing units running machine learning model algorithms, digital signal processors (DSPs), and any suitable processors, controllers, microcontrollers, etc. The computing unit 701 executes the various methods and processes described above, such as the entity relationship extraction method. For example, in some embodiments, the entity relationship extraction method may be implemented as computer software programs tangibly contained in machine-readable media, such as the storage unit 708.

In some embodiments, portions or all of the computer program may be loaded and/or installed onto the device 700 via the ROM 702 and/or the communication unit 709. When the computer program is loaded into the RAM 703 and executed by the computing unit 701, one or more steps of the above entity relationship extraction method of the present disclosure may be executed. Alternatively, in other embodiments, the computing unit 701 may be configured to execute the entity relationship extraction method by other any suitable means, such as firmware.

Various implementations of the systems and technologies described herein may be implemented in digital electronic circuitry, integrated circuits, field-programmable gate arrays (FPGAs), application-specific integrated circuits (ASICs), application-specific standard products (ASSPs), system-on-a-chip systems (SOCs), complex programmable logic devices (CPLDs), computer hardware, firmware, software, and/or combinations thereof. These various implementations may include: implementation in one or more computer programs, which may be executed and/or interpreted on a programmable system including at least one programmable processor, which may be a special-purpose or general-purpose programmable processor, receiving data and instructions from a storage system, at least one input device, and at least one output device, and transmitting data and instructions to the storage system, the at least one input device, and the at least one output device.

Program code for implementing the methods of the present disclosure may be written in any combination of one or more programming languages. This program code may be provided to a processor or controller of a general-purpose computer, special-purpose computer, or other programmable data processing apparatus, so that the program code, when executed by the processor or controller, causes the functions/operations specified in the flowcharts and/or block diagrams to be implemented. The program code may be entirely executed on the machine, partially executed on the machine, as a standalone software package partially executed on the machine and partially executed on a remote machine, or entirely executed on a remote machine or server.

In the context of the present disclosure, machine-readable media may be tangible media that may contain or store programs for use by or in connection with an instruction execution system, apparatus, or device. Machine-readable media may be machine-readable signal media or machine-readable storage media. Machine-readable media may include, but are not limited to, electronic, magnetic, optical, electromagnetic, infrared, or semiconductor systems, apparatus, or devices, or any suitable combination of the foregoing. More specific examples of machine-readable storage media would include an electrical connection based on one or more wires, a portable computer disk, a hard disk, random access memory (RAM), read-only memory (ROM), erasable programmable read-only memory (EPROM or flash memory), optical fiber, a portable compact disc read-only memory (CD-ROM), an optical storage device, a magnetic storage device, or any suitable combination of the foregoing.

To provide interaction with a user, the systems and technologies described herein may be implemented on a computer having: a display device for displaying information to the user (e.g., a CRT (cathode ray tube) or LCD (liquid crystal display) monitor); and a keyboard and a pointing device (e.g., a mouse or a trackball) by which the user may provide input to the computer. Other types of devices may also be used to provide interaction with a user; for example, feedback provided to the user may be any form of sensory feedback (e.g., visual feedback, auditory feedback, or tactile feedback); and input from the user may be received in any form, including acoustic, speech, or tactile input.

The systems and technologies described herein may be implemented in a computing system that includes backend components (e.g., as a data server), or a computing system that includes middleware components (e.g., an application server), or a computing system that includes frontend components (e.g., a user computer with a graphical user interface or a web browser through which a user may interact with the embodiments of the systems and technologies described herein), or any combination of such backend, middleware, or frontend components. The components of the system may be interconnected by any form or medium of digital data communication (e.g., a communication network). Examples of communication networks include local area networks (LANs), wide area networks (WANs), and the Internet.

A computer system may include clients and servers. Clients and servers are generally remote from each other and typically interact through a communication network. The relationship of client and server arises by virtue of computer programs running on the respective computers and having a client-server relationship to each other. The server may be a cloud server, also known as cloud computing server or cloud host, is a host product in the cloud computing service system, to solve the traditional physical host and VPS service (“Virtual Private Server”, or referred to as “VPS”), in the management difficulty, weak business scalability defects. The server may also be a server for a distributed system, or a server that combines blockchain.

It should be understood that various forms of processes shown above may be used, with steps reordered, added, or removed. For example, the steps described in the present disclosure may be executed in parallel, sequentially, or in different orders, as long as the desired results of the technical solutions of the present disclosure are achieved. This is not limited herein.

The above specific embodiments do not constitute a limitation on the scope of protection of the present disclosure. Those skilled in the art should understand that various modifications, combinations, sub-combinations, and substitutions may be made based on design requirements and other factors. Any modifications, equivalent substitutions, and improvements made within the spirit and principle of the present disclosure should be included within the scope of protection of the present disclosure.

What is claimed is:

1. A method for extracting entity relationships, comprising:
inputting a target long text into a target large language model to obtain a target keyword list based on an output result of the target large language model;
inputting the target keyword list into multiple target relationship agents respectively to obtain multiple target regular expressions corresponding to different entity relationships based on output results of the multiple target relationship agents; and
processing texts in a preset text set using the multiple target regular expressions to obtain entity relationship extraction results.

2. The method according to claim 1, wherein obtaining the multiple target regular expressions corresponding to different entity relationships based on the output results of the multiple target relationship agents comprises:
obtaining multiple candidate regular expressions corresponding to different entity relationships based on the output results of the multiple target relationship agents; and
obtaining the multiple target regular expressions corresponding to different entity relationships based on the multiple candidate regular expressions corresponding to different entity relationships.

3. The method according to claim 2, wherein obtaining the multiple target regular expressions corresponding to different entity relationships based on the multiple candidate regular expressions corresponding to different entity relationships comprises:
for each target relationship agent, inputting a candidate regular expression corresponding to a current target relationship agent into the other target relationship agents respectively for the other target relationship agents to evaluate the candidate regular expression; and
in response to determining that evaluation results output by the other target relationship agents are all passed, using the candidate regular expression as a target regular expression.

4. The method according to claim 1, wherein processing the text in the preset text set using the multiple target regular expressions to obtain the entity relationship extraction results comprises:
matching the multiple target regular expressions with the texts in the preset text set to obtain multiple matching texts;
constructing a training dataset based on the multiple matching texts, entities in each matching text and entity relationships among the entities;
training an initial entity relationship extraction model using the training dataset to obtain a target entity relationship extraction model; and
inputting each text in the preset text set into the target entity relationship extraction model to obtain the entity relationship extraction result based on output results of the target entity relationship extraction model.

5. The method according to claim 1, wherein obtaining the target large language model comprises:
obtaining an initial large language model;
repeatedly inputting an initial long text into the initial large language model to obtain multiple initial keyword lists output by the initial large language model;
inputting the multiple initial keyword lists into a preset relationship agent respectively to obtain multiple initial regular expressions output by the preset relationship agent;
selecting an optimal keyword list and a worst keyword list from the multiple initial keyword lists based on the multiple initial keyword lists and the multiple initial regular expressions; and
training the initial large language model based on a positive and negative preference sample pair constituted by the optimal keyword list and the worst keyword list to obtain the target large language model.

6. The method according to claim 5, wherein selecting the optimal keyword list and the worst keyword list from the multiple initial keyword lists based on the multiple initial keyword lists and the multiple initial regular expressions comprises:
using a keyword ranking agent to rank the multiple initial keyword lists to obtain a first ranking result of the multiple initial keyword lists;
using a regular expression ranking agent to rank the multiple initial regular expressions to obtain a second ranking result of the multiple initial keyword lists based on ranking results of the multiple initial regular expressions; and
selecting the optimal keyword list and the worst keyword list from the multiple initial keyword lists based on the first ranking result and the second ranking result of the initial keyword lists.

7. The method according to claim 1, wherein inputting the target long text into the target large language model comprises:
obtaining a first prompt text; and
inputting the first prompt text and the target long text into the target large language model.

8. The method according to claim 1, wherein inputting the target keyword list into the multiple target relationship agents respectively comprises:
obtaining a second prompt text; and
inputting the second prompt text and the target keyword list into the multiple target relationship agents respectively.

9. The method according to claim 3, wherein inputting the candidate regular expression corresponding to the current target relationship agent into the other target relationship agents respectively comprises:
obtaining a third prompt text; and
inputting the third prompt text and the candidate regular expression corresponding to the current target relationship agent into the other target relationship agents respectively.

10. An electronic device, comprising:
at least one processor; and
a memory communicatively connected to the at least one processor;
wherein the memory stores instructions executable by the at least one processor to cause the at least one processor to perform a method for extracting entity relationships, comprising:
inputting a target long text into a target large language model to obtain a target keyword list based on an output result of the target large language model;
inputting the target keyword list into multiple target relationship agents respectively to obtain multiple target regular expressions corresponding to different entity relationships based on output results of the multiple target relationship agents; and
processing texts in a preset text set using the multiple target regular expressions to obtain entity relationship extraction results.

11. The electronic device according to claim 10, wherein obtaining the multiple target regular expressions corresponding to different entity relationships based on the output results of the multiple target relationship agents comprises:
obtaining multiple candidate regular expressions corresponding to different entity relationships based on the output results of the multiple target relationship agents; and
obtaining the multiple target regular expressions corresponding to different entity relationships based on the multiple candidate regular expressions corresponding to different entity relationships.

12. The electronic device according to claim 11, wherein obtaining the multiple target regular expressions corresponding to different entity relationships based on the multiple candidate regular expressions corresponding to different entity relationships comprises:
for each target relationship agent, inputting a candidate regular expression corresponding to a current target relationship agent into the other target relationship agents respectively for the other target relationship agents to evaluate the candidate regular expression; and
in response to determining that evaluation results output by the other target relationship agents are all passed, using the candidate regular expression as a target regular expression.

13. The electronic device according to claim 10, wherein processing the text in the preset text set using the multiple target regular expressions to obtain the entity relationship extraction results comprises:
matching the multiple target regular expressions with the texts in the preset text set to obtain multiple matching texts;
constructing a training dataset based on the multiple matching texts, entities in each matching text and entity relationships among the entities;
training an initial entity relationship extraction model using the training dataset to obtain a target entity relationship extraction model; and
inputting each text in the preset text set into the target entity relationship extraction model to obtain the entity relationship extraction result based on output results of the target entity relationship extraction model.

14. The electronic device according to claim 10, wherein obtaining the target large language model comprises:
obtaining an initial large language model;
repeatedly inputting an initial long text into the initial large language model to obtain multiple initial keyword lists output by the initial large language model;
inputting the multiple initial keyword lists into a preset relationship agent respectively to obtain multiple initial regular expressions output by the preset relationship agent;
selecting an optimal keyword list and a worst keyword list from the multiple initial keyword lists based on the multiple initial keyword lists and the multiple initial regular expressions; and
training the initial large language model based on a positive and negative preference sample pair constituted by the optimal keyword list and the worst keyword list to obtain the target large language model.

15. The electronic device according to claim 14, wherein selecting the optimal keyword list and the worst keyword list from the multiple initial keyword lists based on the multiple initial keyword lists and the multiple initial regular expressions comprises:
using a keyword ranking agent to rank the multiple initial keyword lists to obtain a first ranking result of the multiple initial keyword lists;
using a regular expression ranking agent to rank the multiple initial regular expressions to obtain a second ranking result of the multiple initial keyword lists based on ranking results of the multiple initial regular expressions; and
selecting the optimal keyword list and the worst keyword list from the multiple initial keyword lists based on the first ranking result and the second ranking result of the initial keyword lists.

16. The electronic device according to claim 10, wherein inputting the target long text into the target large language model comprises:
obtaining a first prompt text; and
inputting the first prompt text and the target long text into the target large language model.

17. The electronic device according to claim 10, wherein inputting the target keyword list into the multiple target relationship agents respectively comprises:
obtaining a second prompt text; and
inputting the second prompt text and the target keyword list into the multiple target relationship agents respectively.

18. The electronic device according to claim 12, wherein inputting the candidate regular expression corresponding to the current target relationship agent into the other target relationship agents respectively comprises:
obtaining a third prompt text; and
inputting the third prompt text and the candidate regular expression corresponding to the current target relationship agent into the other target relationship agents respectively.

19. A non-transitory computer-readable storage medium storing computer instructions for causing a computer to perform a method for extracting entity relationships, comprising:
inputting a target long text into a target large language model to obtain a target keyword list based on an output result of the target large language model;
inputting the target keyword list into multiple target relationship agents respectively to obtain multiple target regular expressions corresponding to different entity relationships based on output results of the multiple target relationship agents; and
processing texts in a preset text set using the multiple target regular expressions to obtain entity relationship extraction results.

20. The non-transitory computer-readable storage medium according to claim 19, wherein obtaining the multiple target regular expressions corresponding to different entity relationships based on the output results of the multiple target relationship agents comprises:
obtaining multiple candidate regular expressions corresponding to different entity relationships based on the output results of the multiple target relationship agents; and
obtaining the multiple target regular expressions corresponding to different entity relationships based on the multiple candidate regular expressions corresponding to different entity relationships.
